(19) United States
(12) Patent Application Publication
(10) Pub. No.: US 2025/0384303 A1
(43) Pub. Date: Dec. 18, 2025

(54) Industrial Knowledge base and an AI-enabled Knowledge Base Management System

(71) Applicant: Shaoyuan Zhang, McLean, VA (US)

(72) Inventor: Shaoyuan Zhang, McLean, VA (US)

(73) Assignee: Clear Logic LLC, McLean, VA (US)

(21) Appl. No.: 17/326,314

(22) Filed: May 20, 2021

Related U.S. Application Data
(60) Provisional application No. 63/027,947, filed on May 20, 2020.

(51) Int. Cl. G06N 5/02

(52) U.S. Cl. CPC G06N 5/02

(57) ABSTRACT

A method and a system for building a knowledge base for industrial use and using the knowledge base to manage and control industrial products, processes, resources and systems. The knowledge base uses semantic processing modules and artificial intelligence tools to enable continuous extraction and entry of knowledge into the knowledge base from various sources including user inputs, operation status reports, manuals, websites, diagnosis reports, sensor data, operation sequence, and other static or ephemeral sources. The knowledge base is supported by a knowledge base management system that includes a suite of tools to support knowledge entry, update, retrieval and visualization using both natural language based queries and structured queries with predefined syntax. The system also provides tools to retrieve and assemble knowledges on-the-fly to support industrial applications including to design products, services or production lines, build production process, manage scheduling and flow, monitor and optimize operations, diagnose issues, apply business logics, procure materials and supplies, manage and train workforce, and provide customer supports.

### CROSS-REFERENCE TO RELATED APPLICATIONS

This U.S. non-provisional application claims the benefit of priority under 35 U.S.C. 119(e) to the U.S. provisional application No. 63/027,947 filed on May 20, 2020.

### BACKGROUND OF INVENTION

Manufacturers are upgrading factories with automation technologies to streamline the production processes so that they can respond swiftly to changing customer demands, cope with shortage of skilled labors, and comply with safety, labor, consumer and environmental laws and regulations, where the ultimate goal is to reduce cost, cut waste and increase profit margin.

As manufacturing systems and processes become complex and sophisticated, upgrading a factory often involves deploying sensors and monitoring devices into these systems and processes to monitor the operation of machines and coordinate the tasks performed by machines, tools and human.

An industrial internet of things (IIoT) framework that consists of distributed and interconnected on-premise sensors, on-premise information aggregators, centralized backend servers and application softwares is one of the technologies that enable industrial automation.

In the IIoT framework, sensors and aggregators are deployed throughout the factory floor to monitor and aggregate live, real-time equipment operating status information and to report the collected information to cloud servers for storage, analysis and commands. Servers in the cloud analyze the collected information to determine the operating load and the health of the individual machines, and the coherence of the collaboration among the machines. When an issue is identified, the cloud servers may provide instructions to operators on the factory floor to help them resolve the issue. The cloud servers may also apply analytical algorithms to the collected information to infer and predict future demands for the manufacturing equipment and workers so that equipment and human resources can be timely allocated to respond to the predicted demands.

As the IIoT framework is deployed into factory floors and a vast amount of data is generated by sensors and devices in the framework, there is an urgent need for systematic and reliable way to efficiently and continuously aggregate and organize the data into a manageable and useful repository of knowledge and intelligence that manufacturers can rely on to conduct day-to-day operations with a clear vision and thorough understanding of the state of the business at both workshop level and corporate level. The knowledge repository, i.e. knowledge base, is the master mind and single source of truth that provides all the intelligence and data needed by operations in all areas within an organization, and the operations include design and building of products, services, and production lines, design and establishment of production process, task scheduling and flow management, operation monitoring and optimization, issue diagnosis, business logics development, materials and supplies procurement, management and training of workforce, and customer supports.

Any system that provides a solution to this need must achieve two competing goals, where the first goal is to turn data into usable and manageable knowledge and assets to improve productivity, competitiveness and in turn profits, and the second goal is to keep the complexity of such a system in check so that the additional material and labor cost associated with using and maintaining the system would not exceed the cost savings the system generates.

### SUMMARY OF INVENTION

To meet these goals, we provide a method and a system for building an industrial knowledge base that is an aggregated, well-organized and context aware repository of information about products, resources and processes within an industrial corporation. It is used as a single source of information for managing and controlling industrial systems and processes.

The knowledge base uses semantic processing modules and artificial intelligence tools to enable continuous extraction and entry of knowledge into the knowledge base from various knowledge sources. Information stored within the knowledge base is dynamic in that it is continuously updated with new knowledge that is gained through semantic analysis and knowledge extraction from user inputs, operation status reports, manuals, websites and information feed from many other static or ephemeral sources.

The knowledge base is supported by a knowledge base management system (KBMS) that includes a suite of tools to support knowledge entry, update, and retrieval using both natural language based queries and structured queries with predefined syntax. The knowledge base management system also provides presentation tools for visualizing knowledge within the knowledge base.

The knowledge base management system provides tools to retrieve and assemble knowledges on-the-fly to support industrial applications that design products, services and production lines, build production process, support product and process simulation, manage scheduling and flow, monitor and optimize operations, diagnose issues, apply business logics, procure materials and supplies, manage and train workforce, and provide customer supports.

The knowledge base and the knowledge base management system provide the foundation for building a product life cycle management system. The ominous, well-organized knowledge about every aspect of products, services, processes, labors and resources of an organization enables quick design and launch of new products and services, customer support, problem diagnosis, as well as resource consumption projection, review and planning.

Within the knowledge base, any product or process within an industrial setting may be represented using a special knowledge graph. When such a knowledge graph is used to represent a product, a resource, or a process, it is referred to as a product graph, a resource graph, or a process graph (i.e. a flow graph), respectively. The provisional application No. 63/027,947 contains detailed description of the product graph, resource graph and process graph. Such disclosure in the provisional application is hereby incorporated by reference. These graphs are usually interconnected. For instance, a product graph may contain in a vertex a reference to a process graph that represents the process for making a particular component of the product, and the product graph may also contain a reference to a resource graph that represents a supplier/vendor of that component, a reference to resource graph that represents a partner for designing the product, or a reference to a resource graph that represents a component supplier or a customer of the product.

The product graph, process graph, resource graph and other knowledges stored in the industrial knowledge base serve as a pool of information for producing training materials and simulation tools for training workers on understanding, operating, maintaining and diagnosing machines and tools. For many organization, workforce training is critical and an ever-growing challenge because skilled machine operators and subject matter experts are aging, with an average age of over 50, while the increased complexity in industrial systems means the learning curve is steep and the knowledge barrier between branches of an organization is growing. Our knowledge base and tools offer a solution to the problem.

Scalability, security, and simple and intuitive user interfaces are design objectives with high priority in our system.

Scalability is made possible through the implementation of independent functional modules (e.g. services) that are plugged into a message based communications bus. The pluggable modules use a generic protocol (or API) to interface with the communication bus.

Security is achieved through using a combination of techniques that include user authentication, user privilege control, information access right control, and community based authenticity validation mechanism such as blockchain and the likes.

Simple and intuitive user interfaces is a key design goal in our system. Simplicity is one of the oldest principles of system design as most systems work best if they are kept simple rather than made complex. And as systems must be maintained by human with limited capabilities, any increase in a system's complexity also increases the difficulty and the cost to maintain it. This creates obstacle to system adoption. Our knowledge base and knowledge base management system avoid all unnecessary complexity in its design.

Although the focus of this invention is on building an industrial knowledge base and a supporting management platform, such a solution may be easily extended to support applications in many other domains, including supply chain management, emergency response management, retail process management, and education supports, because the application domain a knowledge base is able to support is determined by the knowledge it stores, and the supporting tools provided by our system is not domain specific.

### BRIEF DESCRIPTION OF DRAWINGS

FIG. 1 is a diagram showing the architecture of a system employing an industrial knowledge base and a knowledge base management system;

FIG. 2 is a diagram showing the structure and components of an industrial knowledge base management system.

FIG. 3 illustrates the internal structure of a knowledge base.

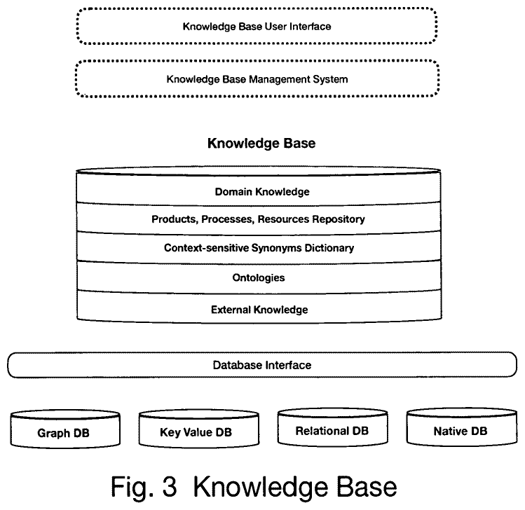

FIG. 4 shows an example of an industrial knowledge base embodied in a graph;

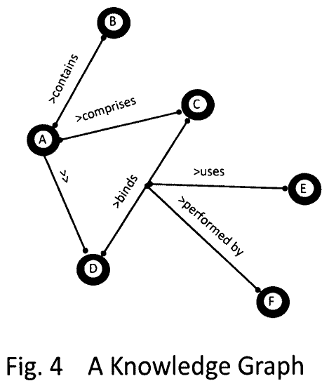

### DETAILED DESCRIPTION

### Knowledge Base

A knowledge base is a repository of structured metadata and data about domains and entities within the domain. The metadata could be attributes and properties about a domain. It could also be attributes, properties, relationships and rules about entities in a domain. Some of these properties, attributes, relationships and rules may be ephemeral.

The knowledge base stores static and time independent information such as the product structure, parts, materials, drawings, suppliers, manufacturers, model numbers, manufacturing processes, transportation processes, maintenance, customer information, and customer service and associated processes. It also stores time-dependent ephemeral information such as the operating status of a machine, the status of a design process, the status of a manufacturing process, the status of a worker, the status of a supplier, or the status of an order, and the like.

The knowledge base also stores context information it derives from information it receives, such as a document, a section in a document, a collection of user inputs, a series of events, a sequence of user interactions with the system, or a sequence of queries a user runs to retrieve knowledge. The knowledge base also stores ontologies as one form of knowledge. They may be manually created by users, or be automatically learned through the semantic parser and semantic reasoner from harvested knowledge.

The knowledge base may be extended by linking external knowledge bases through either specific interface drivers, or commonly used Web services interfaces such as the RESTful or SOAP, and the information exchanged over the interface may use JSON or XML, or other formats.

In terms of its internal structure, the knowledge base comprises one or more relational SQL databases, one or more NoSQL databases such as graph database, key-value pair database, document databases and the like. The knowledge base also comprises a semantic parser, a semantic reasoner and a query engine. The query engine manages knowledge storing and retrieval processes, and supports both natural language based queries and structured queries with predefined syntax. It also ensures data integrity, consistency, accuracy, security and concurrency.

### Automatic Learning

We build our system based on the principle that in order to be user friendly, an artificial intelligence based system must have the ability to understand the context and environment it operates in, interact with human to understand the needs, provide assistance, receive feedbacks and observe, derive and retain knowledge from such interaction.

Our industrial knowledge base has a self learning ability that allows it to aggregate information from a variety of sources and organize the information into logical representation using special knowledge graphs, key-value pairs, lists, matrices, relational tables, and ontologies, etc.

### Knowledge Sources

The knowledge base extracts knowledge from a multitude of sources. Knowledge sources include product design documents, requirement documents, specifications, catalogs, manuals, brochures, trade magazines, conference handouts, research papers, websites, advertisements, textbooks, dictionaries, encyclopedia, customer reviews, and social media.

Knowledge sources also include operating status reports, event/sensor data logs, test results, records of sequences of actions taken by users to diagnose and resolve issues. Knowledge may also be obtained from tracking user's interaction with the system such as information entered by users, user's operation sequence, as well as user sentiment.

Knowledge may be derived from existing knowledge, or from log data stored in the information base.

### Knowledge Representation

In epistemology, there are several overlapping ways of categorizing and denoting knowledge. In one denotation, knowledge falls into one of three categories: descriptive, procedural, and acquaintance. In another, there are six types of knowledge, namely a priori, a posteriori, propositional, non-propositional, explicit and tacit.

As the focus of this invention is on knowledge pertaining to industrial products, processes and applications, we have chosen to denote knowledge based on its content and use, instead of the abstract epistemology denotation. As a result, our knowledge base handles the following types of knowledges, where top tier knowledge types, e.g. tier 1 or tier 2 may contain lower tier ones, e.g. tier 2 or tier 3.

| | |
|---|---|
| Tier 1 Knowledge | products |
| | services |
| | resources |
| | processes |
| | requirements |
| | inference |
| | prediction |
| | context |
| Tier 2 Knowledge | decisions |
| | commands |
| | actions |
| | activities |
| | events |
| | business rules |
| | regulations |
| | theories |
| | semantics |
| | languages |
| Tier 3 Knowledge | attributes (i.e. properties) |
| | relationships |
| | logical operations |

The knowledge type “Attribute” in tier 3 may be represented by key value pairs. Both the key and value fields in an “Attribute” may be a simple numerical value, an alphanumerical string, an URI or other types of resource identifier, a reference to another attribute, and/or a reference to a piece of knowledge in tier 1 or tier 2.

The knowledge type “Relationship” in tier 3 comprises static and persistent relationships such as inheritance, composition, association and aggregation, causal activity relationships such as tasks and events found in process flows, and logical relationships that are usually found in rules, regulations, theories, and requirements.

Knowledge in tier 1 and tier 2 is stored in a hybrid data structure comprising graphs, lists, key-value pairs, matrices and relational database tables.

A knowledge statement, which could be a text statement that describes a relationship between two entities and comes in the form of triples such as <subject, predicate, object>, may be represented using two vertices and one edge in a graph. One of the two vertices may represent the “subject”, the other vertex may represent the “object”, and the edge may represent the “predicate”, or the relationship. Within each vertex, attributes of the subject or object may be stored, where an attribute may be entered using a knowledge statement in the form of <entity, attribute, value> or the like. Attributes within a vertex may also be used to store references to one or more vertices and edges representing additional subjects/objects or relationships when the knowledge represented by the vertex necessitates such references. The edge may store attributes that describe relationships, i.e. “predicate”. Similar to a vertex, an edge may also store attributes that refer to one or more vertices and edges representing additional subjects/objects or relationships when the relationship noted by the predicate is complex and necessitates such reference. The references make the graph in our system a more complex structure than a typical graph.

In a text-based knowledge statement that describes an attribute or a relationship, every word or phrase that appears in the knowledge statement may be associated with a set of synonyms. This allows the semantic of the knowledge statement to be flexible and adaptable to a user. With the synonyms, the knowledge stored in the special knowledge graph is no longer restrained by the specific words that are used in the knowledge statement to describe an attribute or a relationship. Instead the stored knowledge represents a general broader concept beyond the limitation of the specific semantics in the text statement.

The synonym sets are domain and context-sensitive. A dictionary of synonym sets, may be built and stored in a separate data structure or a database. To link to a synonym set in the dictionary, a vertex or an edge in the special knowledge graph adds an attribute that refers to a synonym set in the dictionary. Such as separately stored dictionary ensures that only one copy of synonyms are used in a consistent and domain appropriate manner throughout the knowledge base.

The dictionary of synonyms may be a text-based traditional dictionary in which any given word is linked to a set of its context-sensitive synonyms. The dictionary may also be in the form of a word vector space that is created using word embedding techniques, where each word is encoded into a real-valued vector in the space, and words having similar meanings are in closer proximity in the vector space.

However, there may be cases where the knowledge representation must be accurate and precise, in which cases only the specific keywords as entered in the knowledge statement may be used to represent the knowledge. In such cases, no synonyms are linked into the corresponding attribute in the vertices or edges. Instead only keywords that appear in the knowledge statement are stored in attribute and knowledge query and retrieval is based on exact matching of keywords.

In some other cases, knowledge may be represented using a numerical value, an alphanumerical string, a vector, a matrix, or any other meaningful format. Natural language processing (NLP) softwares and language modeling tools are used to parse the natural language input and extract key words and key phrases that corresponds to knowledge statements. A semantic parser and a semantic reasoner are then used to encode (or tokenize) the words and represent each encoded word as a numerical value, an alphanumerical value, a real value, or a vector. Such values are then further encoded to represent the piece of knowledge extracted from the text that is entered. The further encoded result may be in the form of a numerical value, a vector, or a matrix and is a final representation of the knowledge in the knowledge base.

### Knowledge Entry and Extraction

Knowledge may be entered manually using a text-based interface similar to a command line interface (CLI). Knowledge may also be entered as natural language statements, in short phrases, sentences, or an entire document.

The text statement that describes the knowledge (i.e. a knowledge statement) may be entered in pre-defined syntax using a pre-defined set of commands. This form of knowledge entry is quick to implement through a syntax parser, but may be limited in its flexibility and may not work well with complex relationships.

An alternative is to loosen the syntax requirement by accepting knowledge statement in the form of triples such as <entity, attribute, value> and <subject, predicate, object>, where every field in the triple, e.g. entity, attribute, value, subject, predicate, object, may contain any words and phrases typed in by the user. In the case that a URI/URL value is entered for all the fields in the triples <subject, predicate, object>, the resulted text statement resembles one used in Resource Description Framework (RDF).

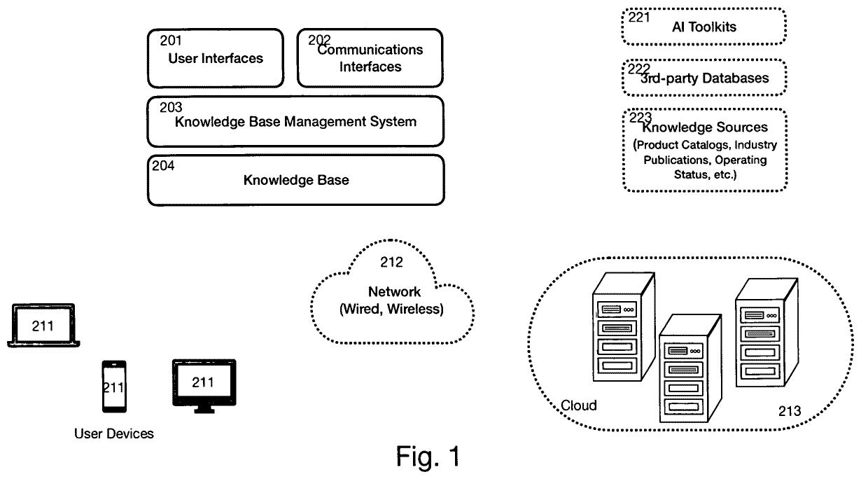

To reduce the computing time on parsing and encoding the text, some commonly used words and phrases may be replaced with symbols. For instance, words such as “has”, “comprises” and “contains” that are commonly used to indicate structural relationships may be replaced with a symbol “>>”, as shown in FIG. 1.

The text-based interface may also accept text-based knowledge statement in batches, just like a typical command line interface, where a batch of statement may be loaded from a file, or a storage database located either locally on a computer or remotely over a computer network, where the file is identified by a universal resource identifier/locator (URI or URL).

Knowledge may also be entered in the form of natural language statements or sentences without any syntax restrictions. The natural language based knowledge statements may be entered into the text-based interface as described above, provided that the text-based interface has been enhanced with natural language processing (NLP) softwares and language modeling tools that can parse the natural language input and extract key words and key phrases that corresponds to knowledge statements. A semantic parser and a semantic reasoner are then used to encode (or tokenize) the words and represent each with a numerical value, an alphanumerical value, or a real value. Such values are then further encoded to represent the piece of knowledge extracted from the text that is entered. The further encoded result (i.e. the knowledge) may be represented in the form of a numerical value, a vector, a matrix, a graph, or any other meaningful format.

When the knowledge input is provided in the form of a text document, an extensive set of natural processing tools may be invoked to process the text documents to extract knowledge statements for further processing and encoding in a way similar to what is described in the paragraph above.

### Context Understanding

Context is a setting within which an action, an event or a decision takes place. Context understanding and extraction is an important aspect of a knowledge base. A good understanding of the context would allow decision making algorithms and machine learning models to selectively focus their processing time and resources on information that are most relevant to the context and produce the context-sensitive results most useful to the users. Context sensitive processing generally produces better results with less time and resource consumption.

Context is ephemeral in that it changes overtime as users finish one task and move on the next. There may also be concurrent contexts when a user is multitasking. Therefore, context understanding is a steady and persistent process that takes place in the background for as long as the system is active.

Our knowledge base derives context from information that comes from several different sources. One source is the sequence of user interaction with the system, such as the commands a user has typed in or the sequence of operations a user has performed. Another source is the email and chat messages users exchanges over a collaboration platform. Yet another source is the documents and manuals a user has viewed, and the search phrases a user has typed into the system.

Alternatively, context may also be established by asking a user to manually enter context information into the system using a user interface.

### Context Representation

As discussed in the previous section, context is a setting within which an action, an event or a decision takes place. In our knowledge base, context is represented by an abstract model and a corresponding set of tags (or labels) that may come in the form of keywords or phrases.

The context representation could be obtained through analyzing and summarizing texts in documents, manuals, search phrases or sequence of actions generate one or more abstract modelings of the setting, and a set of corresponding keywords and key phrases that accurately describe the setting. The keywords and key phrases serve as tags (or labels) to index the context in the knowledge for storage, retrieval and search purposes, while the abstract model is an encoded, abstraction description of the context.

The abstract model of context could be created using one of several techniques.

One modeling technique is the bag of words model that aggregates the high-frequency words and phrases that appear in a document. The words may be stored in their text/ASCII form, or be encoded into real-valued word vectors using the word embedding technique first. The keywords and key phrases could be extracted from headings, title or summary of a text document, or any part of the document. The high frequency words are also used to tag the corresponding context model in this case.

Another modeling technique is to not only extract high frequency words, but also extract the proximity and sequencing information between these in the document. A context model generated using this technique may be stored in a graph, where a vertex corresponds to a word and possibly its synonyms while an edge stores proximity and sequencing information between words represented by two vertices the edge connects. Words could be represented using ASCII strings, or real-valued word vectors.

Yet another modeling technique is to use machine learning methods such as recurrent neural networks (RNN), transformers, or the combination of both to generate an artificial intelligence (AI) model for the context. The AI model includes various types of neural networks. Such a method identifies an AI model as a close representation of sentences/paragraphs or other combination of words in a text document by running the text through a set of trained neural networks to find one with the highest probability of match, as this highest probability match represents texts that are closest in their meanings.

### Query Engine

The query engine receives and processes a search phrase, where the search phrase could use a pre-defined syntax such as SQL, a collection of keywords, or a natural language type question. With the assistance of semantic parser, the query engine transforms such a search phrase into a sequence of instructions directly understandable by the knowledge base engine so that the knowledge base engine may perform the instructions to generate the desired results.

Sometimes the query engine may need to transform a query phrase into a set of sub queries, then distribute the sub-queries to the knowledge base engine, which then carry out the subqueries to generate and return a series of results to the query engine. The query engine then aggregates the series of results to generate the final search results.

The query engine have built-in algorithms and scripts for performing every one of its functions. The query engine may also relied on external algorithms and scripts to perform those functions. Such external algorithms and scripts may invoked through a secure interface and the generated results are returned over a secured channel. The secure interfaces and channels include secure RESTful interface, secure Pub/Sub micro-service interfaces, and the message routing platform that is disclosed below.

While processing a query, the query engine may derive new knowledge about the structure or the flow under management from the data. This new knowledge is stored into the appropriate knowledge bases. The new knowledge may also be placed in the cache area of the knowledge base for expedited processing of future queries.

The query engine may associate a query with context and use the context information to understand the search phrases, clarify or narrow down its search scope, and to select most relevant results based on the context.

The query engine has a learning ability in that it can be taught by a user on how to perform a query. A user may enter via a plurality of user interfaces context or relevant knowledge information that helps the query process. A user may also explicitly enter a formula, rule sets, or a sequence of queries in the form of a script into the query engine. Such scripts may be used by the query engine to perform a complex query. For instance, in order to calculate the labor cost of making a product, the user may provide the query engine a list of words that are used to describe labor in the knowledge, such as worker, employee, technician, engineer, and a list of words used to describe the cost, such as salary, price, fee, rate, etc., and a formula for computing the labor cost. The query engine then processes such instructions by work with the semantic engine to parse the word lists, identify synonyms of each words to create a vocabulary set that is linked to cost calculation, and store the vocabulary set along with the computation formula into the knowledge base as a native script for future use.

The query engine comprises the following component:
An interface to the message routing platform that allows the query engine to communicate with other system components to perform the following tasks:
(1) to use algorithms and scripts in the semantic engine to parse search texts entered by a user;
(2) to use algorithms and scripts in the knowledge engine that help in generating sub-queries;
(3) to use the database engine for the information base to run queries to retrieve information.
An internal query results aggregator.
An interface to external algorithms and scripts (as micro services) that aggregate and process query results.
An interface to the user interface to display the query results. The user interfaces include graphic user interfaces (GUI) and local and remote user interface of any type running over a variety of protocols such as HTTP, RDP, RTP, RTSP, UDP, RESTful, SOAP etc.

### Knowledge Base Engine

A knowledge base engine performs underline knowledge functions including data create, read, update and delete (CRUD).

A knowledge base engine also manages knowledge base security including authentication, access control, data encryption and intrusion detection.

The knowledge base engine also performs on-demand or periodic clean up, pruning and optimization of data stored in the knowledge base, with the help of semantic engines. Pruning removes redundant, outdated or inaccurate knowledge from the knowledge base. It may also rearrange information in the knowledge, or update the indexing, to optimize search speed.

The knowledge base engine may utilize one or more semantic engines to analyze the data stored in information bases to derive knowledge about properties and relationships that can be added into or linked into the knowledge base.

A knowledge base engine may support a command line user interface, a command interpreter, and interactive tools and interfaces for initiating or managing all the tasks it performs.

A knowledge base engine's functionality may be extended by linking external modules through a secured interface.

### Knowledge Base Management System

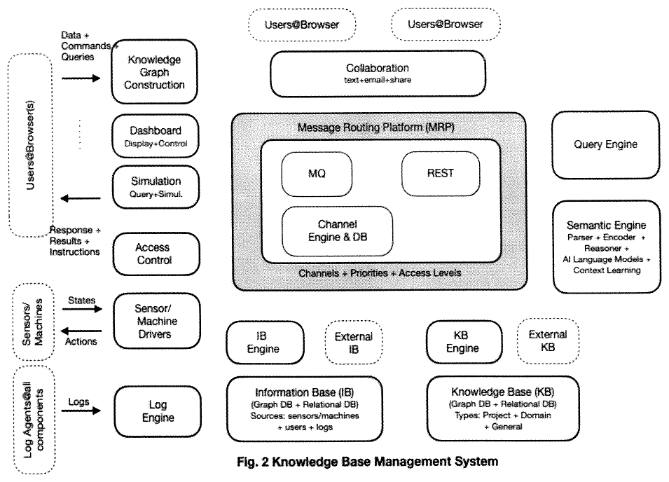

The knowledge management system, as shown in FIG. 2, is designed around the principles of simplicity, scalability, security and evolvability. It comprises distributed databases and processing engines that are interconnected over a message-based communications network.

A baseline configuration of the management system comprises an information base (IB) for storing data entered by users, data from machines and sensors, and log data, a knowledge base (KB) for storing knowledges derived from data in the information base or data stored in external or remote locations, a message routing platform that provides communications channels for all engines and modules within the system, a collaboration platform that supports user collaboration over text, email or voice/video calls, a suite of processing engines that include a semantic engine, a log engine, an access control engine, drivers for remote sensors and/or machines, and a suite of user interface modules including a dashboard module, knowledge base construction modules, editing modules, visualization modules, and a simulation module for building and runnings simulations of products or processes. Additional information bases, knowledge bases, and processing engines may be linked into the baseline system at any point in time as needed.

The information base has an internal information base engine that provides the capability to create, read, update and delete (CRUD) data. It also provide a port that allows an external semantic engine to be linked into the database to read and process the stored data.

Similarly, the knowledge base is paired with a knowledge base engine and a port for external access upon authorization.

The processing engines such as semantic engine, log engine, access control engine can be distributed to one or more physical machines and virtual machines on geographically distant devices. Every processing engine may comprises a plurality of modules in the form of Web services or micro-services that may also be distributed to one or more physical machines or virtual machines, where every module is identified by a URL, URI or a network address of the like. The Web services and micro-services are dynamically invoked and communicate over the message routing platform.

### Information Base

The information base (IB) is a repository of all data or links to data that has been received by the knowledge management system.

The information base is a repository of sensor data or event data collected from a variety of sources. For instance, the information base may store the status and event data that is generated during the design or development of a structure. The information base is also a log database that stores user activities logs, machine activities logs, and the likes. The information base also stores the actual content of, or the links to text documents, manuals, test results, diagnosis reports, user operation sequence, and any information that is used to derived knowledge for the knowledge base.

The information base is a virtualized database that is built on top of a combination of NoSQL databases and relational databases.

### Information Base Engine

An information base engine includes a command line user interface, a command interpreter, and interactive tools and interfaces for data storage, retrieval, navigation, edit and deletion. As the information base may use a hybrid graph+relational database, the interactive tools must include at lease a graph browser, a traditional relational database engine, and a data merger that merges data retrieved from a graph with data from a relational database.

The information base engine may support an interactive interface with one or more semantic engines to support information analysis and knowledge learning performed by the semantic engines and knowledge base.

The information base engine may support an interactive interface with one or more query engines, with the help of semantic engines, to support search queries issued by users or other modules in the system.

The information base engine may support a data sharing interface with the knowledge base so that the knowledge may link by reference to data physically stored in the information base. This data sharing mechanism avoids storing duplicated copies of data in both information base and knowledge base.

The information base engine may perform on-demand or periodic clean up, pruning and optimization of data stored in the knowledge base.

### Real-Time Message Routing Platform

The message routing platform manages the passing and routing of all the data, commands and state information among information bases, knowledge bases, semantic engines, query engines, log engines, access control engines and all the user interface modules. Remote users, sensors, machines may also use the message routing platform to communicate with send information to or retrieve information from the system. Messages may be sent point-to-point, or point-to-multipoint (fanned-out). Messages may also be sent and received either asynchronously or synchronously.

The message routing platform, supporting both message queue (MQ) and REST protocol, allows data and message to be communicated over message channels at one of a plurality of priority levels. A channel could be either an asynchronous channel over MQ, or a synchronous channel over REST/HTTP. Using information provided by the access control engine, the message routing platform determines which channel is available to a user based on a user's subscription, and a user's access privilege level. The routing of messages in MQ is supported by a combination of message/event queuing and distributing techniques. The message routing platform may run over various communications networks such as wired LAN, WLAN and wireless 4G, 5G, 802.11x and Bluetooth.

Messages may be assigned priority based on their importance, urgency, latency tolerance and synchronousness requirements. For urgent and low latency tolerance messages, dedicated and persistent channels may be established between two communicating modules.

To support asynchronous communication channels over MQ, the message routing platform comprises a publish/subscribe engine, a message queuing mechanism, and a message distribution engine. The publish/subscribe engine receives data publish requests from an information source such as a remote sensor, a remote machine, or a user interface module like graph construction module, dashboard, play-pad, registers it and then wait for subscribers to sign up. Subscribers send subscribe requests to the publish/subscribe engine so that they may receive data published by information sources.

Using the message routing platform, a user interface module such as the graph construction module may send data to and retrieve data from the information base using synchronous communication channels over REST as the interaction between them is causal. The communications between the query engine and the information base and/or the knowledge base, or between the dashboard and query engine, are also likely performed over synchronous communication channels.

Meanwhile, remote sensor/machine may sends sensor data to the knowledge base management system over an asynchronous channel using MQ. It is done by having a sensor driver within the data management system subscribe to the sensor channel that is published by the remote sensor/machine. The driver may need to be authenticated before being granted the subscription right. The driver then forwards sensor data it receives to the information base.

As 5G wireless network technology matures, it is possible that a the message routing platform may use the 5G network's built in point to point data routing mechanism to connect the distributed components within the knowledge base management system, where components such as the graph construction modules, dashboard, play pad, query engines, semantic engines, access control engine, log engines, sensors, as well as the information bases and knowledge bases are all deployed within the 5G network and every component is assigned an identifier by the 5G network. As a result routing of messages is done by the underlying 5G network in real time without a need for separate message communications mechanisms like MQ and REST.

### User Collaboration Platform

The user collaboration platform, supported by client browsers, web services based drivers and the message routing platform, allows users at different locations to enter and edit information on a graphic user interface interactively in real-time, and exchange thoughts and updates over text, email or videos. Through the collaboration platform, commands, data, status and other real-time information may be exchanged between users over the user devices such as desktop computers, mobile tablets, mobile phones, workbench computer stations etc.

### Semantic Engine

The semantic engine comprises at least a semantic parser module, a semantic reasoner module, a knowledge extraction module, a context understanding module, and a language modeling module. Every module may be supported by artificial intelligence (machine learning) algorithms and methods.

The semantic engine parses and analyzes information in the information base (IB), or information from external sources, to automatically learn and infer knowledge and context, generate knowledge and context represented in the form as described above in the section “Knowledge Base”, and store the knowledge and context into the knowledge base. As discussed earlier, artificial intelligence models, machine learning methods may be employed to help with knowledge and context discovery, using either supervised learning approach or unsupervised learning approach. In the unsupervised approach, knowledge is learnt whenever it is available, and the knowledge base is built over time as more information is processed to extract knowledge. Old knowledge may also be updated when new extraction algorithms become available.

The semantic engine may periodically process data in the information base using updated algorithms or a changing or updated context, with some level of guidance and feedback from human.

For instance, the semantic engine may query the information base to extract information and transform such information into generalized knowledge about a structure such as a product and a project, or generalized knowledge about a flow. The generalized knowledge is then stored in the knowledge base (KB) for later use. For instance, the KB, assisted by information in the IB, may act as an information sources for future queries, domain specific information retrieval or as the basis for making recommendations or predictions.

The semantic engines may have various capabilities. Some may be pre-programmed to understand a fixed set of domain-specific vocabulary and relationships, while others may possess the learning ability that allows them to build up on-the-fly the vocabulary and their understanding of relationships.

Semantic engine receives texts as input, parses them, uses a logical analyzer, with the help of language model and knowledge model, to produce a logical/relational representation of the words and phrases, maps the logical representation with metadata describing the context or meaning of the text, then stores the mapping of logical/relational representation and the corresponding metadata into a knowledge base. The analysis and mapping steps may be iterated to produce multiple mapping, or to optimize the mapping. The mappings could be a direct explicit association, or could be a fuzzy association represented by a model trained using artificial intelligence algorithms.

### Log Engine

The log engine tracks all the interaction among all components of the systems, with which the system derives further knowledge about both the user and the domain the user operates within. The log engine comprises a log database, a plurality of log servers that can be dynamically created and assigned based on location, data load, and event data types, and a distributed set of log agents that are also dynamically created and deployed based on the location, data load, event data types, and the likes.

The log engine receives and aggregates information collected by the log agents. Log agents are deployed in both modules within the data management system as well as sensors and machines outside the system. Log records are stored in one of the information bases.

### Access Control Engine

The access control engine provides authorization and authentication services to each user of the system. It registers users and controls a user's access to a device, a location, and a function based on the user's authorized level of access.

As the system is divided into a plurality of zones, a user is allowed access to some of the zone depending on the access level the user is given. The access level may include view only, view and edit, and view and delete. The access level may also be custom-defined. Every user is also assigned a role. An access level may be individually assigned to a user, or it may be associated with a role. When access level is associated with a role of the user, all users who are assigned a specific role automatically assume the same access level that is pre-configured for the role.

The access control engine follows a process enforced by the system administrator to obtain approval for registering a user.

### Sensor/Machine Drivers

The drivers/adapters for sensors and machines allow the sensors and machines to send states and updates to the knowledge base management system, and to receive commands and instructions from the knowledge base management system. The commands and instructions may be issued by a user, or automatically generated by the system using intelligence stored in the knowledge base.

### Browser-Based User Interfaces (UI)

The user interface (UI) has modules corresponding to several functions that include graph construction, dashboard, simulation pad, and user collaboration.

### Knowledge Construction Module

A graph is stored in a semantic based format in the system. The choices of the semantic based format includes JSON and XML.

The knowledge construction module receives knowledge statements from a graphic window, a command line interface or an external source over a communication network channel.

A user can manually build knowledge representation of a product using the construction module by manually enter knowledge statements into the system.

The knowledge construction module offers a text input area into which a user can type in knowledge statements one line at a time, in a batch, or loaded from a batch file containing a list of knowledge statements.

For a device with a touch screen, a user may free-hand draw a node or a link on the screen and the graph construction can employ a graphics and character recognition function to understand and convert user's free-hand drawing into semantic information for storage.

The knowledge construction module also has a graphical area, e.g. a window, that displays an updated view of the structure as commands are being entered by the user. The user can also click on an area in the graphical structure to zoom in and out, and to view and edit the properties and attributes associated with the knowledge graph in the area of focus.

Updates to the knowledge base can come from a wide range of sources depending on the application of the knowledge base is used in.

### Knowledge Base Visualization

A knowledge base visualization module presents on a graphic user interface information stored in a knowledge base structure including a knowledge graph so that the user may view and edit the graph using either the command line interface or the graphic display.

A knowledge base visualizer comprises a knowledge graph browser, which traverses a knowledge representation (e.g. graph) to retrieve data for viewing, query processing, knowledge learning, as well as pruning and optimization. Pruning removes redundant, outdated or inaccurate knowledge from the knowledge base. It may also rearrange information in the knowledge, or update the indexing, to optimize search speed.

A knowledge base browser traverses one or more knowledge graph, reads the properties of a node, uses the semantic engine to interpret the meaning of the properties, and produces a structure diagram, a flow diagram or a combination of both to show the structure of an object, or the flow of tasks, and data that is passed from one task to another, and the synchronization and coordination of the tasks if any is required. In this process, the graph browser retains knowledge it has learned about a structure, or a flow, and adds such knowledge into the knowledge base.

A knowledge base visualizer also comprises a renderer that displays graphically the knowledge graph. The renderer may display the nodes, links and attributes/properties in styles (e.g. colors, layouts, and appearance) that are determined by preset rules. The renderer may also display the nodes, links and properties in styles controlled by algorithms and rules provided by users, hence allowing the graphics to be customized.

### Dashboard

The dashboard module displays a dashboard through which a user may view status, run queries, and issue action commands.

The dashboard supports one or more browser pages for a user to run queries to retrieve knowledge. The query is processed by a query engine.

The dashboard supports one or more browser pages for a user to run queries to generate statistics on schedules, cost, performances, and issues. It has built in data visualization tools that plots graphical charts and plots to visualize the generated statistics. It also allows a user to run machine learning algorithms to generate knowledge from the statistics and stored the knowledge into knowledge base.

The dashboard also supports one or more generated browser pages that display the real-time state of an object such as a product or a process, which is represented by knowledge graphs. The displayed information may be dynamically determined based on which portion of the graph a user is focusing on, or which resources or structure a user has clicked on. It may also be determined by displaying a list of relevant resources, structures, components, parameters so that a user may select one to view its real-time status.

The dashboard may also support a browser page for a user to configure the settings for one or more semantic engines. A semantic engine is used to analyze the structural or flow information stored in the system. It is linked into the system using a Web protocol such as HTTP, HTTPS, REST and SOAP.

A user can use the dashboard to configure a product or components of the product so that they automatically receive information and updates from a machine or a factory/facility that is manufacturing the product and/or components in the physical domain. The information and updates may also be received from a supplier of the product/components, or a sales site.

The dashboard supports one or more browser pages for managing and controlling access to the system by users of the system. Many access control management schemes may be employed.

For instance, a user of the system may be assigned one or more access privilege levels. Functional blocks inside the system may be assigned access permissible levels that correspond to the users' access privilege levels. A user whose access privilege level is at or above the access permissible level of a functional block is allowed to access and control the functional block.

Last but not the least, the dashboard may also learn about a user's interest through tracking a user's interaction with the system and then make automatic inference and recommendations. The result of the learning is that the dashboard may have a “recommended” section for displaying additional information that a user did not request but may find useful. For instance, the dashboard may display in the recommended section synonyms of a word a user is typing into the command line, or additional segments of a graph a user may be interested in viewing, or additional statistics relating to the statistic values being viewed by the user.

Such recommendation may provide the user a shortcut to a next action item that the user would otherwise have to run another query to find and launch. It provides a fluid human-machine interface.

To support the automatic user interest/action recommendation, the dashboard must send a command entered by a user to the log engine to storage and tracking, and to the semantic engine and the knowledge base for learning, in addition to sending it to its normal recipient.

### Simulation Pad

The simulation pad pad allows a user to enter changes and receives simulated status updates triggered by the changes, all done in a simulated mode without having impact on a live working system. The simulation provides a user the ability to estimate how a structure change, a flow change, or a resource availability change will affect the delivery schedule, the cost and availability of a product, a project, a service, as well as the impact on the supply chain.

The simulation pad also allows a user to build a product or a process using information in the knowledge base and run a simulation of the product or process to test the design.

### User Collaboration

The user collaboration module provides a graphic window that displays the presence status and activities of other users. It also provides instant message, email as well as document and data sharing capabilities that a user can use to communicate, interact and coordinate with other users so that they can collaborate on tasks such as entering knowledge statement, browsing knowledge graphs, monitoring and viewing states, issuing commands to remote machines or sensors, simulating a flow scenario, or diagnosing and trouble-shooting a problem.

### Expansion Interface Drivers

The web services based drivers (also called adapters) are the interface between the knowledge base management system and the external system, applications and softwares that are either local or remote.

The external systems may be connected to the web services based drivers via either wired or wireless networks. The 5G networks that are scheduled to be placed in service by late 2019 and early 2020 have made the promises of providing network access to all kinds of devices (i.e. Internet of Things), which would overcome to issue of limited IP addresses in the current 4G technology and makes it possible to deploy a light-weight Web server on any device in the IoT realm.

Each web services driver is specifically designed for a particular external system, resource or software. A driver may be implemented as a light-weight Web server (HTTP server) that supports REST API and provides control of and monitoring access to local or remote devices, sensors, machines, equipment and collects data from local or remote sensors. On one end the web services could use the REST API (RESTful) or SOAP protocols to communicate with the external systems. On the other end the web services drivers post information it receives from external systems into one or more channels in the message routing platform, and receives information from the channels in the message routing platform to which it subscribes.

What is claimed:

1-19. (canceled)

20. An industrial knowledge management system comprising:
one or more processors;
memory for storing instructions executable by the one or more processors;
an industrial knowledge repository that comprises one or more structure graphs and one or more flow graphs,
wherein each of the one or more structure graphs corresponds to an entity and comprises:
a first plurality of nodes,
wherein each of the first plurality of nodes corresponds to a component of the entity and contains attributes of the component, and wherein each of the attributes is represented using a combination of text, a structure graph, and a flow graph, and
a first plurality of edges connecting the first plurality of nodes,
wherein each of the first plurality of edges connects two of the first plurality of nodes and represents one or more relationships between the components that the two of first plurality of nodes correspond to, and wherein each of the one or more relationships is represented using text and a structure graph;
wherein each of the one or more flow graphs corresponds to a process and comprises
a second plurality of nodes, wherein each of the second plurality of nodes corresponds to a task in the process and stores information associated with execution of the task, wherein a portion of the information is ephemeral;
a second plurality of edges connecting the second plurality of nodes, wherein each of the second plurality of edges stores information associated with transition between tasks, wherein the information is represented using a combination of text, structure graph, and a flow graph;
a knowledge entry module that comprises at least one interface for receiving raw information associated with one or more entities or one or more processes, wherein
the raw information is received from a plurality of information sources,
the raw information comprises at least one of a predefined set of commands, one or more keywords, one or more phrases, one or more sentences, one or more drawings, and one or more documents, and
the at least one interface is selected from a plurality of interfaces including a text based interface, a graphical interface, and a communication network based interface;
an information base for storing the raw information associated with one or more entities or one or more processes, wherein the information base is managed by an information base engine.
a semantic engine configured to process the received raw information to generate a first set of structured data associated with one or more entities and a second set of structured data associated one or more processes;
a knowledge base engine configured to
provide an interface to the industrial knowledge repository; and
process the first set of structured data and the second set of structured data to update the one or more structure graphs and the one or more flow graphs in the industrial knowledge base repository;
a query engine that in response to receiving an information request structured according to a query language, queries the industrial knowledge repository and returns a response, wherein the information request is associated with at least one of a plurality of tasks including:
producing training materials associated with the one or more entities and the one or more processes based on information stored in the industrial knowledge repository;
designing a new product based on information associated with the one or more entities and the one or more processes; and
building a simulation tool based on the structured data associated with the one or more products and the one or more processes.

21. The system of claim 20, further comprising:
an access control module that provides security control to the industrial knowledge repository and the knowledge management system.

22. The system of claim 21, further comprising
a simulation tool comprising a user interface, the simulation tool configured to
retrieve a third set of structured data associated with a product or a process from the industrial knowledge repository;
display the third set of structured data on the user interface;
receive a request from a user to modify the third set of structured data;
modify the third set of structured data;
construct a digital model of the entity or the process based on the modified third set of structured data;
retrieve a set of data from the information base;
activate a simulation of the entity or the process using the set of data retrieved from the information base and the constructed digital model of the entity or the process to produce outputs;
present the outputs on the user interface;
retrieving a set of data from the information base;
activating a simulation of the entity or the process using the set of data retrieved from the information base and the digital model of the entity or the process and producing outputs;
present the outputs on the user interface.

23. The system of claim 20, further comprising:
a subscription/publication based real-time message routing platform for routing data and commands between the knowledge entry.

24. The system of claim 20, wherein the plurality of information sources include at least one of user inputs, brochures, manuals, research publications, design documents, requirement documents, trouble reports, diagnosis logs, meeting minutes, customer reviews, Web articles, encyclopedia, dictionaries, books, catalogs, publication of rules and regulations, and legal documents, and third-party knowledge bases.

25. The system of claim 20, wherein the system communicates with a user collaboration platform to support knowledge entry, knowledge query and knowledge presentation.

26. A method for managing an industrial knowledge base using an industrial knowledge management system, the method comprises:
maintaining, via an interface provided by a knowledge base engine, an industrial knowledge repository that comprises one or more structure graphs and one or more flow graphs,
wherein each of the one or more structure graphs corresponds to an entity and comprises:
a first plurality of nodes,
wherein each of the first plurality of nodes corresponds to a component of the entity and contains attributes of the component, and wherein each of the attributes is represented using a combination of text, a structure graph, and a flow graph, and
a first plurality of edges connecting the first plurality of nodes,
wherein each of the first plurality of edges connects two of the first plurality of nodes and represents one or more relationships between the components that the two of first plurality of nodes correspond to, and wherein each of the one or more relationships is represented using text and a structure graph;
wherein each of the one or more flow graphs corresponds to a process and comprises
a second plurality of nodes, wherein each of the second plurality of nodes corresponds to a task in the process and stores information associated with execution of the task, wherein a portion of the information is ephemeral;
a second plurality of edges connecting the second plurality of nodes, wherein each of the second plurality of edges stores information associated with transition between tasks, wherein the information is represented using a combination of text, structure graph, and a flow graph;
receiving, via at least one interface provided by a knowledge entry module, raw information associated with one or more entities or one or more processes,
wherein the raw information is received from a plurality of information sources, the raw information comprises at least one of a predefined set of commands, one or more keywords, one or more phrases, one or more sentences, one or more drawings, and one or more documents, and
the at least one interface is selected from a plurality of interfaces including a text based interface, a graphical interface, and a communication network based interface;
storing in an information base the raw information associated with one or more entities or one or more processes, wherein the information base is managed by an information base engine.
processing, by a semantic engine, the received raw information to generate a first set of structured data associated with one or more entities and a second set of structured data associated one or more processes;
processing, by the knowledge base engine, the first set of structured data and the second set of structured data to update the one or more structure graphs and the one or more flow graphs in the industrial knowledge base repository;
in response to receiving an information request structured according to a query language, querying, by a query engine, the industrial knowledge repository and returning by the query engine a response, wherein the information request is associated with at least one of a plurality of tasks including:
producing training materials associated with the one or more entities and the one or more processes based on information stored in the industrial knowledge repository;
designing a new product based on information associated with the one or more entities and the one or more processes; and
building a simulation tool based on the structured data associated with the one or more products and the one or more processes.

27. The method of claim 26, further comprising:
providing, by an access control module, security control to the industrial knowledge repository and the knowledge management system.

28. The method of claim 27, further comprising
retrieving, via a user interface provided by a simulation tool, a third set of structured data associated with a product or a process from the industrial knowledge repository;
displaying, by the simulation tool, the third set of structured data on the user interface;
receiving, by the simulation tool, a request from a user to modify the third set of structured data;
modifying, by the simulation tool, the third set of structured data;
constructing, by the simulation tool, a digital model of the entity or the process based on the modified third set of structured data;
retrieving, by the simulation tool, a set of data from the information base;
activating, by the simulation tool, a simulation of the entity or the process using the set of data retrieved from the information base and the constructed digital model of the entity or the process to produce outputs;
presenting, by the simulation tool, the outputs on the user interface.

29. The method of claim 26, further comprising:
providing a subscription/publication based real-time message routing platform for routing data and commands between the knowledge entry.

30. The method of claim 26, wherein the plurality of information sources include at least one of user inputs, brochures, manuals, research publications, design documents, requirement documents, trouble reports, diagnosis logs, meeting minutes, customer reviews, Web articles, encyclopedia, dictionaries, books, catalogs, publication of rules and regulations, and legal documents, and third-party knowledge bases.

31. The method of claim 26, further comprising
communicating with a user collaboration platform to support knowledge entry, knowledge query and knowledge presentation.

32. A non-transitory computer readable medium having program instructions embodied therewith to manage an industrial knowledge base, the program instructions executable by one or more processors to perform a method comprising:
maintaining, via an interface provided by a knowledge base engine, an industrial knowledge repository that comprises one or more structure graphs and one or more flow graphs,
wherein each of the one or more structure graphs corresponds to an entity and comprises:
a first plurality of nodes,
wherein each of the first plurality of nodes corresponds to a component of the entity and contains attributes of the component, and wherein each of the attributes is represented using a combination of text, a structure graph, and a flow graph, and
a first plurality of edges connecting the first plurality of nodes,
wherein each of the first plurality of edges connects two nodes of the first plurality of nodes and represents one or more relationships between the components that the two of first plurality of nodes correspond to, and wherein each of the one or more relationships is represented using text and a structure graph;
wherein each of the one or more flow graphs corresponds to a process and comprises
a second plurality of nodes, wherein each of the second plurality of nodes corresponds to a task in the process and stores information associated with execution of the task, wherein a portion of the information is ephemeral;
a second plurality of edges connecting the second plurality of nodes, wherein each of the second plurality of edges connect two nodes of the second plurality of nodes and stores information associated with transition between tasks that the two nodes correspond to, wherein the information is represented using a combination of text, structure graph, and a flow graph;
receiving, via at least one interface provided by a knowledge entry module, raw information associated with one or more entities or one or more processes, wherein
the raw information is received from a plurality of information sources,
the raw information comprises at least one of a predefined set of commands, one or more keywords, one or more phrases, one or more sentences, one or more drawings, and one or more documents, and
the at least one interface is selected from a plurality of interfaces including a text based interface, a graphical interface, and a communication network based interface;
storing in an information base the raw information associated with one or more entities or one or more processes, wherein the information base is managed by an information base engine.
processing, by a semantic engine, the received raw information to generate a first set of structured data associated with one or more entities and a second set of structured data associated one or more processes;
processing, by the knowledge base engine, the first set of structured data and the second set of structured data to update the one or more structure graphs and the one or more flow graphs in the industrial knowledge base repository;
in response to receiving an information request structured according to a query language, querying, by a query engine, the industrial knowledge repository and returning by the query engine a response, wherein the information request is associated with at least one of a plurality of tasks including:
producing training materials associated with the one or more entities and the one or more processes based on information stored in the industrial knowledge repository;
designing a new product based on information associated with the one or more entities and the one or more processes; and
building a simulation tool based on the structured data associated with the one or more products and the one or more processes.

33. The medium of claim 32, wherein the program instructions stored therewith are executable by one or more processors to perform the method further comprising:
providing, by an access control module, security control to the industrial knowledge repository and the knowledge management system.

34. The medium of claim 33, wherein the program instructions stored therewith are executable by one or more processors to perform the method further comprising:
retrieving, via a user interface provided by a simulation tool, a third set of structured data associated with a product or a process from the industrial knowledge repository;
displaying, by the simulation tool, the third set of structured data on the user interface;
receiving, by the simulation tool, a request from a user to modify the third set of structured data;
modifying, by the simulation tool, the third set of structured data;
constructing, by the simulation tool, a digital model of the entity or the process based on the modified third set of structured data;
retrieving, by the simulation tool, a set of data from the information base;
activating, by the simulation tool, a simulation of the entity or the process using the set of data retrieved from the information base and the constructed digital model of the entity or the process to produce outputs;
presenting, by the simulation tool, the outputs on the user interface.

35. The medium of claim 32, wherein the program instructions stored therewith are executable by one or more processors to perform the method further comprising:
providing a subscription/publication based real-time message routing platform for routing data and commands between the knowledge entry.

36. The medium of claim 32, wherein the plurality of information sources include at least one of user inputs, brochures, manuals, research publications, design documents, requirement documents, trouble reports, diagnosis logs, meeting minutes, customer reviews, Web articles, encyclopedia, dictionaries, books, catalogs, publication of rules and regulations, and legal documents, and third-party knowledge bases.

37. The medium of claim 32, wherein the program instructions stored therewith are executable by one or more processors to perform the method further comprising:
communicating with a user collaboration platform to support knowledge entry, knowledge query and knowledge presentation.
